(19) United States
(12) Patent Application Publication
(10) Pub. No.: US 2026/0251177 A1
(43) Pub. Date: Aug. 27, 2026

(54) LINK-BASED BEARING COMPENSATION DEVICE

(71) Applicant: Schumann, Inc., Troy, OH (US)

(72) Inventor: Stephen Arthur Schumann, Troy, OH (US)

(21) Appl. No.: 19/546,948

(22) Filed: Feb. 23, 2026

Related U.S. Application Data
(60) Provisional application No. 63/762,265, filed on Feb. 24, 2025.

(51) Int. Cl. F16C 29/00

(52) U.S. Cl. CPC F16C 29/001; F16C 2326/10

(57) ABSTRACT

A compensation device for a load bearing, a rail bearing assembly and a material transport system. The compensation device cooperates with a load bearing through link assemblies that have a link housing and link bearings to allow rotational self-alignment of the rail bearing about each of a roll axis, a pitch axis and a yaw axis. In this way, it responds to a load that is being carried by the load bearing through a rotational freedom of motion between the compensation device and the load bearing at a location that is at or near a center of action of the load bearing while limiting at least some translational freedom of motion. The compensation device may be either directly secured to the load bearing through the link assemblies or indirectly secured to the load bearing through an inner block and an outer block that in turn are secured to one another through the link assemblies that may be made up of numerous link couples. One form of the compensation device may provide three-link connectivity while another form provides two-link connectivity. The compensation device is especially applicable to linear bearings and linear rails where imprecise surfaces or rail non-parallelism are present.

This application claims the benefit of U.S. Provisional Patent Application Ser. No. 63/762,265 that was filed on Feb. 24, 2025 the entire disclosure of which is expressly incorporated by reference herein.

The present disclosure relates generally to an alignment compensation device for bearing systems, and more particularly to a bearing alignment compensation device that utilizes specially arranged links to isolate misalignment errors between a bearing mounting structure and the load that the bearing is supporting.

### BACKGROUND

Linear rail bearing systems are used to reduce friction during movement of an object along a rail. Examples of such systems may be found in U.S. Pat. Nos. 4,527,840 and 5,158,372. Numerous industrial and commercial activities employ such linear rails and bearings (also referred to as linear guides, linear slides or the like) to provide positioning and low-friction conveyance of a workpiece along a rail, track, shaft, or related single dimension guide. Examples may include lathes, assembly machines, robotic equipment and linear transport systems, the latter of which includes material or equipment transport systems such as those used in an automotive assembly line. Traditionally, because linear rails and bearing blocks are machined to relatively tight tolerances, it was important to have the rails and bearings be mounted on rigid, flat, and straight surfaces, especially in configurations where the rails are arranged in pairs that extend down an elongate parallel path. Regardless of the configuration, failure to adhere to such tight tolerances and associated precision assembly, such as through mounting them on imprecise or flexible surfaces, particularly where the workpiece is heavy, leads to unnecessary frictional or offset loads that adversely impact the service life and capacity of one or both of the bearings and the rails.

### SUMMARY

With the foregoing in mind, the author of the present disclosure has developed a device that compensates for various forms of rail and bearing mounting imperfections which cause misalignment between a linear bearing and its corresponding rail. Such imperfections (collectively referred to within the present disclosure as misalignment unless the context calls for a greater degree of specificity) may include uneven, bent, curved, warped, flexible or related undulations in the rail, as well as situations involving multiple rails where the rails that are intended to be placed parallel to one another are in fact not parallel in one or more dimensions. This compensation device allows a limited range of multidimensional misalignment characteristics between the bearing block mounting surface and the rail mounting surface as a way to provide compensatory movement of the bearing block to precisely align with the rail even though both the rail and bearing block are mounted on imprecise or flexible surfaces. This provides significant improvements of linear bearing and rail service life or load capacity despite misalignment or limited flexibility of mounting surfaces.

According to an aspect of the present disclosure, a compensation device for a linear rail bearing is disclosed. The compensation device includes an outer block, an inner block and numerous link assemblies. The outer block has an aperture formed therein such that numerous outer block corners are formed within and contiguous with the aperture, wherein at least a pair of the corners are arranged to be opposed to one another with each defining an outer block slot therein such that their respective outer block slots extend toward one another along an outer block first diagonal axis. The inner block is sized to be placed within the aperture such that a gap is formed between an outer wall defined by the inner block and an inner wall of the outer block that corresponds to the aperture. The inner block has numerous inner block corners in the outer wall at least a pair of which are arranged to be diagonally opposed to one another. Each of the inner block corners define an inner block slot therein such that their respective inner block slots extend diagonally toward one another along an inner block first diagonal axis. The first diagonal axis of the inner block and the first diagonal axis of the outer block are substantially collinear with one another. Each of the numerous link assemblies has a link first end and a link second end. The link first end has a link first orbital bearing formed therein to at least rotatably engage the inner block through a corresponding one of the inner block slots. The link second end has a link second orbital bearing formed therein to at least rotatably engage the outer block through a corresponding one of the outer block slots such that each of the numerous link assemblies movably couples the inner block to the outer block through the first and second orbital bearings.

According to another aspect of the present disclosure, a compensation device for a load bearing that is situated in Cartesian space and configured to move translatably along a major axis thereof is disclosed. The compensation device includes numerous link assemblies each of which is movably coupled to the load bearing. Each of the link assemblies include a link housing with a first end and a second end that are spaced apart from one another along an elongate dimension. Apertures are formed in each of the first and second ends along a substantial centerline of the elongate dimension, while an orbital bearing is disposed within each of the apertures. The orbital bearings are configured to rotationally self-align the load bearing about each of a roll axis, a pitch axis and a yaw axis within the Cartesian space. In this way, upon a load that is being carried by the load bearing, each of the numerous link assemblies may respond through a freedom of motion about each of these axes at a location that is substantially at a center of action of the load bearing.

According to another aspect of the present disclosure, a compensation device for a linear rail bearing is disclosed. The compensation device includes an outer block, an inner block and numerous link assemblies. The outer block has numerous outer block slots formed therein that extend toward one another. The inner block has numerous inner block slots formed therein that extend toward one another. The inner block and the outer block cooperate with one another through a stacked relationship such that their respective slots are aligned with one another along an axis within a global Cartesian framework. The numerous link assemblies each have a link first end and a link second end where the link first end has a link first orbital bearing formed therein to at least rotatably engage the inner block through a corresponding one of the inner block slots while the link second end has a link second orbital bearing formed therein to at least rotatably engage the outer block through a corresponding one of the outer block slots. In this way, each of the numerous link assemblies movably couples the inner block to the outer block through the first and second orbital bearings.

According to another aspect of the present disclosure, a compensation device for a linear rail bearing is disclosed. The compensation device includes an outer block, an inner block and numerous link assemblies. The outer block has numerous outer block flanged mounting surfaces formed therein, while the inner block has numerous inner block flanged mounting surfaces formed therein. The outer block and the inner block cooperative with one another through a stacked relationship such that their respective flanged mounting surfaces are substantially aligned with one another along an axis within a Cartesian space. Each of the numerous link assembly couples are formed by a pair of links each of which has a link first end and a link second end. The link first end at least rotatably couples the inner block to the outer block, wherein each of the outer block flanged mounting surfaces substantially aligns with a corresponding one of the inner block flanged mounting surfaces. In addition, each of the numerous link assembly couples are secured such that the link first end is rotatably secured to the inner block flanged mounting surface while the link second end is rotatably secured to the outer block flanged mounting surface. A pair of the numerous link assembly couples are substantially aligned along the axis.

According to another aspect of the present disclosure, a rail bearing assembly is disclosed. The rail bearing assembly includes a rail bearing and a compensation device. The rail bearing is situated in Cartesian space and configured to move translatably along a major axis thereof. The rail bearing includes a bearing housing and numerous rail engagement members. The bearing housing has a rail-receiving slot formed therein that extends along an elongate rail axis. The numerous rail engagement members are arranged within the bearing housing to permit linear translational movement of the linear bearing along the elongate rail axis; and a compensation device movably cooperative with the rail bearing through a numerous links each of which includes a link housing that has a first end and a second end spaced apart from one another along a link housing elongate dimension. The link housing has numerous apertures formed therein along a substantial centerline of the elongate dimension, where each is situated substantially at each of the first and second ends. A pair of orbital bearings are each disposed within a respective one of the numerous apertures and configured to rotationally self-align the rail bearing about each of a roll axis, a pitch axis and a yaw axis within the Cartesian space. In this way, each of the numerous links responds to a load that is being carried by the bearing through a freedom of motion about each of these axes at a location that is substantially at a center of action of the rail bearing.

According to another aspect of the present disclosure, a rail bearing assembly is disclosed. The rail bearing assembly includes a rail bearing and a compensation device movably cooperative with the rail bearing. The rail bearing is situated in Cartesian space and configured to move translatably along a major axis thereof. The rail bearing includes a bearing housing that has a rail-receiving slot formed therein that extends along an elongate rail axis. In addition, the rail bearing includes numerous rail engagement members that are arranged within the bearing housing to permit linear translational movement of the linear bearing along the elongate rail axis. The compensation device cooperates with the rail bearing through numerous link couples each of which includes a pair of link housings and a pair of link bearings for each of the pair of link housings. Each pair of link housings have a first end and a second end spaced apart from one another along a link housing elongate dimension. In addition, each of the pair of link housings has numerous apertures formed therein along a substantial centerline of the elongate dimension each of which is situated substantially at each of the first and second ends. Each of the pair of link bearings is disposed within a respective one of the numerous apertures and configured to rotationally self-align the rail bearing about each of a roll axis, a pitch axis and a yaw axis within the Cartesian space. In this way, each of the pair of link housings defines a freedom of motion about each of these axes at a location that is substantially at a center of action of the rail bearing in response to a load that is being carried by the rail bearing.

According to another aspect of the present disclosure, a material transport system is disclosed. The material transport system includes a numerous rails, numerous linear rail bearings and a compensation device. The numerous rails are arranged parallel to each other to extend along their respective elongate rail axis within a Cartesian space. Each of the numerous linear rail bearings are configured to move translatably along a corresponding elongate rail axis. The rail bearing includes a bearing housing defining a rail-receiving slot formed therein that extends along the respective elongate rail axis. The rail bearing further includes numerous rail engagement members that are arranged within the bearing housing to permit linear translational movement of the linear bearing along the respective elongate rail axis. The compensation device includes numerous links each of which is movably coupled to the linear rail bearing. Each of these links include a link housing made up of a first end and a second end spaced apart from one another along a link housing elongate dimension. The link housing has numerous apertures formed therein along a substantial centerline of the elongate dimension, where each of the apertures are situated substantially at a corresponding one of the first and second ends. Each of a pair of orbital bearings is disposed within a respective one of the numerous apertures and configured to rotationally self-align the orbital bearing to which that compensation device is movably coupled about each of a roll axis, a pitch axis and a yaw axis within the Cartesian space. In this way, upon a load that is being carried by the bearing, each of the numerous links may respond through a freedom of motion about each of these axes at a location that is substantially at a center of action of a respective one of the linear rail bearings.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1A depicts a top perspective view of an embodiment of a three-link compensation device in a disassembled state along with a linear rail bearing;

FIG. 1B depicts a bottom perspective view of the three-link compensation device of FIG. 1A in an as-assembled state and slidably attached to a rail through the linear rail bearing;

FIG. 1C depicts a top perspective view of the three-link compensation device of FIG. 1B and how it engages with the rail and linear rail bearing;

FIG. 1D depicts a bottom perspective view of a two-link compensation device with outer dimensions that generally mimic the three-link compensation device of FIG. 1A;

FIG. 2A depicts a bottom perspective view of the three-link compensation device and linear rail bearing of FIG. 1B, now with the rail removed;

FIG. 2B depicts the bottom perspective view of the embodiment of the compensation device and linear rail bearing of FIG. 2A, now with a boot placed around the compensation device and a portion of the linear rail bearing;

FIGS. 3A through 3C depict respectively a top elevation, side elevation and front elevation view of the three-link compensation device, linear rail bearing and rail of FIGS. 1B and 1C, showing how an elongate axis of the link assemblies are arranged to pass through a center of action of the linear rail bearing along each major axis of a Cartesian coordinate system during situations where the linear rail bearing and a rail are substantially aligned;

FIG. 4A depicts a front elevation cutaway view of the embodiment of the compensation device and linear rail bearing of FIGS. 3A through 3C when the linear rail bearing engages a rail in a properly-aligned configuration;

FIG. 4B depicts a front elevation cutaway view of the embodiment of the compensation device and linear rail bearing of FIG. 4A when the linear rail bearing is slightly misaligned relative to a rail;

FIGS. 5A through 5D depict respectively a bottom perspective, front elevation, side elevation and bottom view of another embodiment of a three-link version of the compensation device in an as-assembled state and attached to a linear rail bearing;

FIGS. 6A through 6D depict respectively a bottom perspective, front elevation, side elevation and bottom view of a two-link version of the compensation device of FIGS. 5A through 5D;

FIG. 7A depicts a perspective view of another embodiment of a three-link compensation device in an as-assembled state and attached to a linear rail bearing;

FIG. 7B depicts a perspective view of a two-link variant of the compensation device of FIG. 7A;

FIGS. 8A through 8G depict various views of another embodiment of a three-link compensation device attached to a linear rail bearing;

FIGS. 9A through 9G depict various views of a two-link version of the compensation device of FIGS. 8A through 8G as well as its attachment attached to a linear rail bearing;

FIG. 10A depicts a material transport system that uses compensation devices, linear rail bearings and parallel rails according to one or more embodiments shown or described herein;

FIG. 10B depicts a material transport system of FIG. 10A where the outer blocks for two of the three compensation devices has been removed for clarity;

FIG. 10C depicts how the pair of axially-aligned three-link version of the compensation devices of FIGS. 10A and 10B provide roll, pitch and yaw freedom of motion relative to the primary rail while the two-link version of the compensation device of FIGS. 10A and 10B provides the roll, pitch, yaw freedom of motion as well as lateral translational freedom of motion along the Y axis relative to the secondary rail;

FIG. 11A depicts compensation devices similar to those of FIGS. 10A through 10C, now coupled to circular rail bearings that ride on a circular rail; and

FIG. 11B depicts the compensation devices of FIG. 11A where the outer blocks have been removed for clarity.

It will be appreciated that for the sake of clarity, elements depicted in the drawings are not necessarily to scale, and that certain elements may be omitted from some of the drawings. It will further be appreciated that certain reference numerals may be repeated in different figures to indicate corresponding or analogous elements.

### DETAILED DESCRIPTION

The author of the present disclosure has discovered that one technological difficulty to overcome relates to how to have a rail bearing to perform along rails that are misaligned or misshapen so that when placed in service where lengthy sections of such rails are present (such as in a material transport system that in turn may form part of, or be used in conjunction with, an assembly line or other industrial or commercial enterprise), the rail bearing doesn't fail prematurely or work improperly under heavy loads (such as when a weighty workpiece is carried along the rail as part of such industrial or commercial enterprise) due to misalignment between the bearing mounting surface and the rail. In one non-limiting example, the author of the present disclosure has discovered that a rail bearing used in a material transport system that in turn is used to convey automotive engines, frames and other large components in an automotive assembly line is particularly susceptible to excessive wear and premature failure when used on a factory floor over extended lengths where misalignment or other undulations in the rail are present. The present technical solution as provided by this disclosure is to use a compensation device for situations where unevenness, bentness, relative curvature, warpage, flexibility or misalignment is present in a rail or other support surfaces where a rail bearing is used in order to prevent undue wear and reduced conveying efficiency of the rail bearing. In a general form, the compensation device includes a load-engaging structure and a bearing-engaging substructure that are coupled to each other through two or more links. In this way, the links allow the bearing to adjust to and align with a misaligned rail, thereby reducing wear and increasing operability for so-called “real-world” situations.

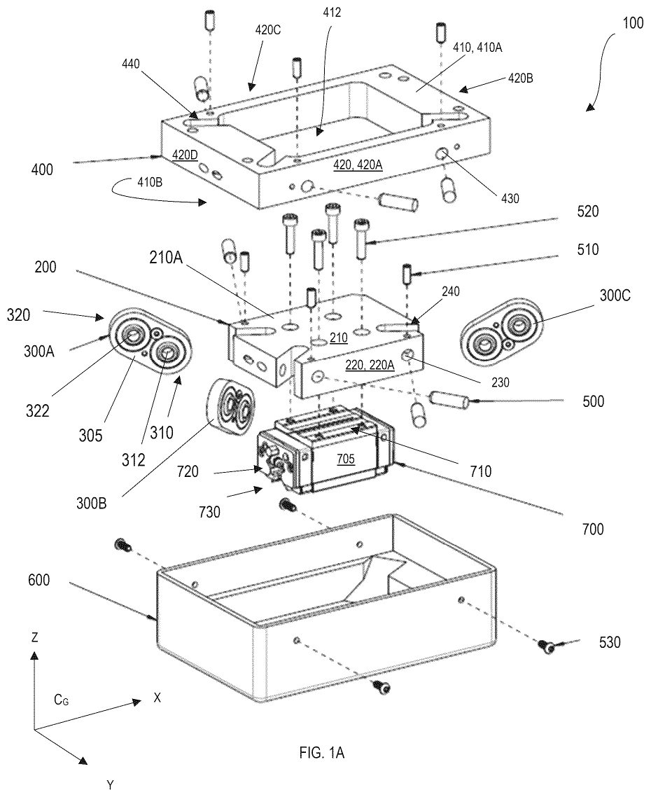

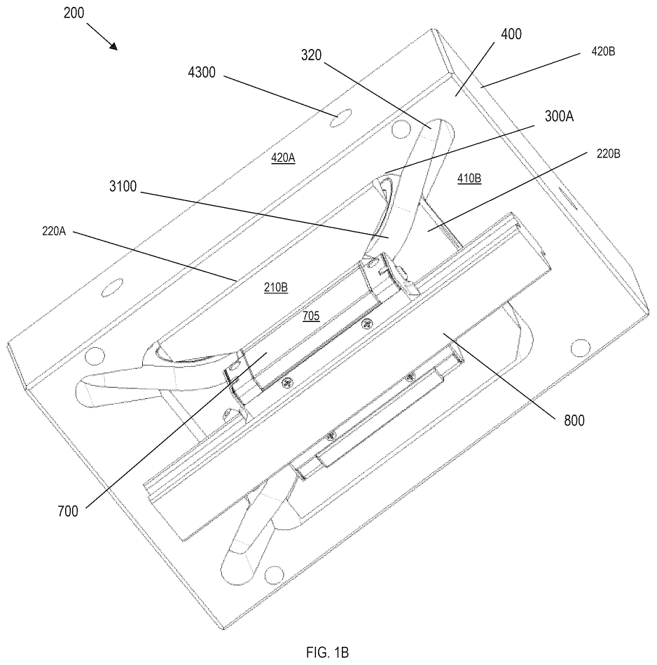

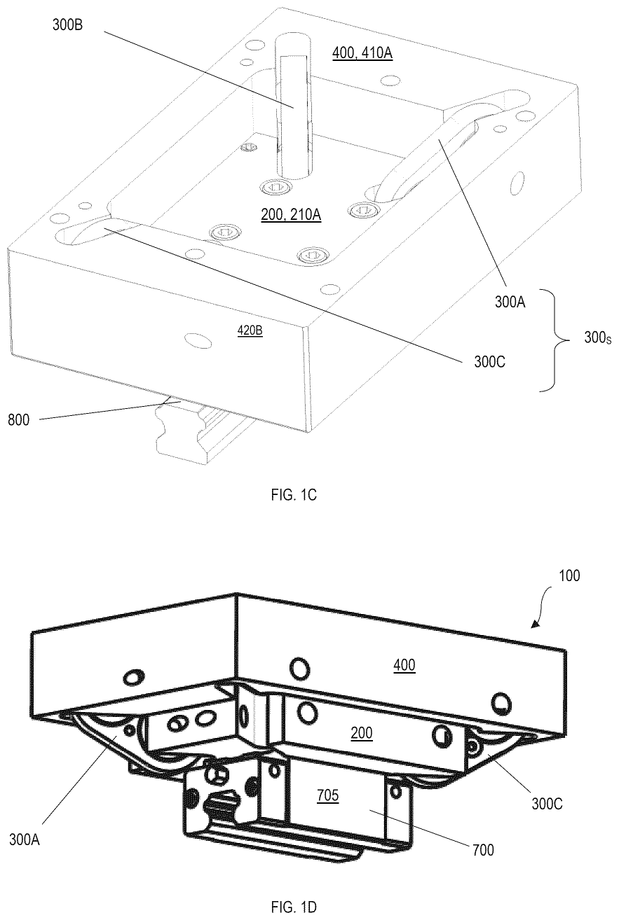

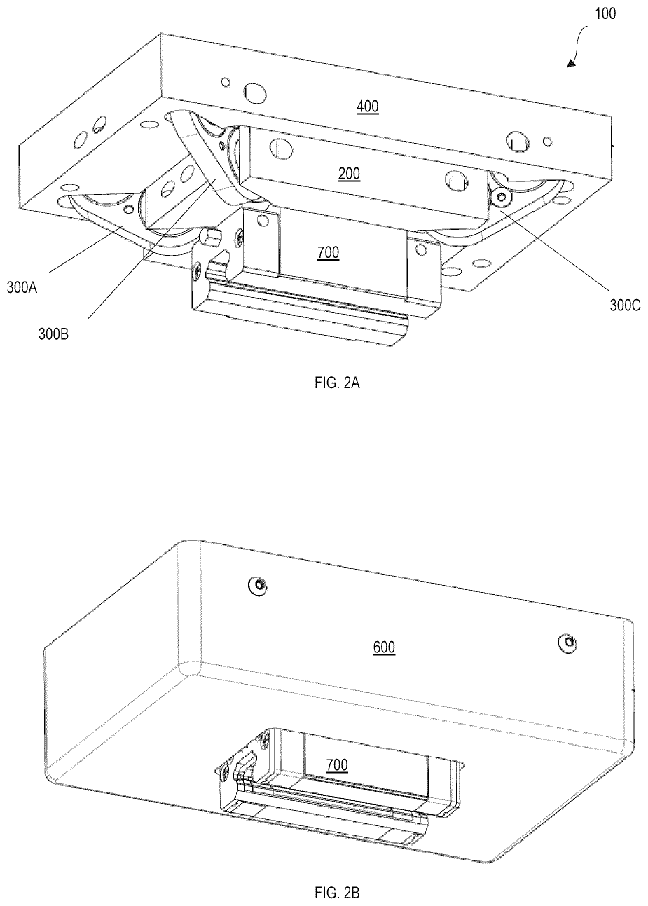

Referring first to FIGS. 1A through 1D, 2A and 2B, a compensation device 100 for use with a load bearing 700 that is currently shown in the form of a linear rail bearing (also referred to herein as bearing block) and a rail 800 is shown. While much of the present disclosure discusses the specific interaction of the compensation device 100 with a rail bearing embodiment in general and a linear rail bearing embodiment in particular, it will be appreciated that other forms of the load bearing 700 are also configured to cooperate with the compensation device 100 and that all such forms of load bearings 700 are within the scope of the present disclosure. Likewise, the compensation device 100 may be used with a rotary bearing (not shown) such as that configured to hold a shaft, axle or related structure that defines an axisymmetric cross-sectional profile.

Referring with particularity to FIGS. 1A through 1C, 2A and 2B, a three-link version of the compensation device 100 is shown. As can be seen in the exploded view of FIG. 1A, the compensation device 100 includes an inner block 200, numerous link assemblies 300A, 300B, 300C (collectively 300) and an outer block 400. In this way, the outer block 400 functions as one particular form of the aforementioned load-engaging structure, while the inner block 200 functions as one particular form of the aforementioned bearing-engaging substructure. As shown, the compensation device 100 is situated in three-dimensional Cartesian space (referred to herein as a global Cartesian framework C_{G}) that includes a first axis X, a second axis Y and a third axis Z and is configured to cooperate with an upward-facing major surface 710 that is formed as part of a bearing housing 705 of the load bearing 700 to slide along a rail (not presently shown) that extends along the first axis X. In this configuration, the upward-facing major surface 710 functions as a mounting surface for a downward-facing mounting surface of the inner block 200 that will be discussed in more detail as follows. Within the present disclosure, the first axis X is that which, under normal operating conditions, does not restrict movement of the load bearing 700. As such, it coincides with the travel direction of the load bearing 700 and as such is also referred to as the axis of travel or axis of movement. An optional boot 600 is sized and shaped to substantially contain the compensation device 100 therein to act as at least a partial protection against the ambient environment including moisture, dust, dirt, debris or other elements that could adversely impact the functioning of either or both of the compensation device 100 and the load bearing 700. As shown, apertures or related means may be used to secure the outer block 400 to a respective workpiece mounting surface, either directly or indirectly. In one form, the outer block 400 may connect to a mounting block, carriage plate, bearing block or related structure. In another form, the outer block 400 may itself be configured to form such mounting block, carriage plate, bearing block or related structure. It will be appreciated that both forms are within the scope of the present disclosure.

Together, the three axes of any Cartesian space and the movement of one or more components of the compensation device 100 (or any other rigid body, for that matter) within such space can be described through six degrees of freedom that includes three translational degrees and three rotational degrees that permit such components or compensation device 100 to experience translationally forward/backward movement along the first axis X, left/right movement along the second axis Y and up/down movement along the third axis Z, as well as rotationally roll, pitch and yaw movement about the respective first axis X and the second axis Y and third axis Z. In this way, the movement, position or orientation of the compensation device 100 within and relative to the global Cartesian framework C_{G} as well as a particular component (such as the link assemblies 300) within and relative to a local Cartesian framework C_{L} may be described using its corresponding Cartesian space.

It will be further appreciated that although the compensation device 100, along with load bearing 700, are shown as sliding or otherwise traveling back and for the along the elongate dimension of the rail 800 in the first axis X such that the sides of all three components face a lateral, side-to-side dimension along the second axis Y, there is no requirement that—when placed in service—the compensation device 100, load bearing 700 and rail 800 need exist in the orientation depicted. Likewise, although the rails 800 depicted herein define a prismatic cross-sectional shape, there is no requirement that they such shape; as such, other shapes of both axisymmetric and non-axisymmetric cross-sectional profiles are possible and within the scope of the present disclosure.

As can be seen, the load bearing 700 defines an elongate channel 720 that substantially aligns with the first axis X. Generally, four ball or roller tracks (not shown) form generally oval-shaped paths on inner surfaces of the portion of the load bearing 700 that defines the elongate channel 720. As discussed herein, the aforementioned link assemblies 300 and their spherical bearings 312, 322 allow cooperative movement between the inner block 200 and the outer block 400 of each compensation device 100. In particular, the linear pivot motion made possible by the spherical bearings 312, 322 is a close approximation but not geometrically precise about the center of action A_{C} of the load bearing 700. As such, a freedom of motion about each of the roll, pitch and yaw axes within Cartesian space that takes place substantially at the center of action A_{C} is that which may be either exactly coincident with such center of action A_{C} or immediately adjacent the same.

As can be seen, the inner block 200 defines a substantially rectangular three-dimensional shape, although it will be appreciated that other shapes are within the scope of the present disclosure so long as they provide the necessary cooperation between the inner block 200, link assemblies 300, outer block 400 and load bearing 700. The inner block 200 includes a pair of opposing major surfaces 210A, 210B (collectively 210) that are bounded by numerous minor surfaces 220A, 220B, 220C and 220D (collectively 220). In one form, major surface 210B defines a generally downward-facing mounting surface that facingly engages an upward-facing surface of the load bearing 700. Likewise, the major surface 210A defines an opposing (that is to say, upward-facing) surface. The inner block 200 defines slots 240 that are formed in and face outward from corners that extend between the opposing major surfaces 210A, 210B.

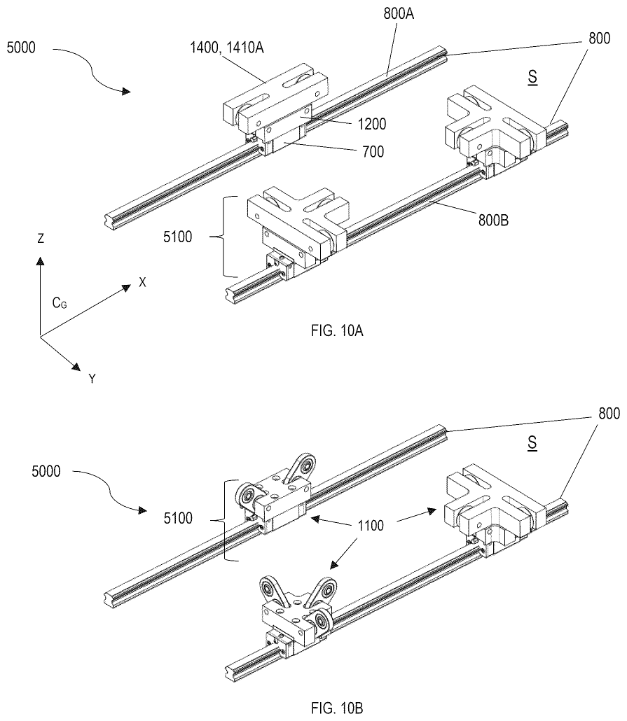

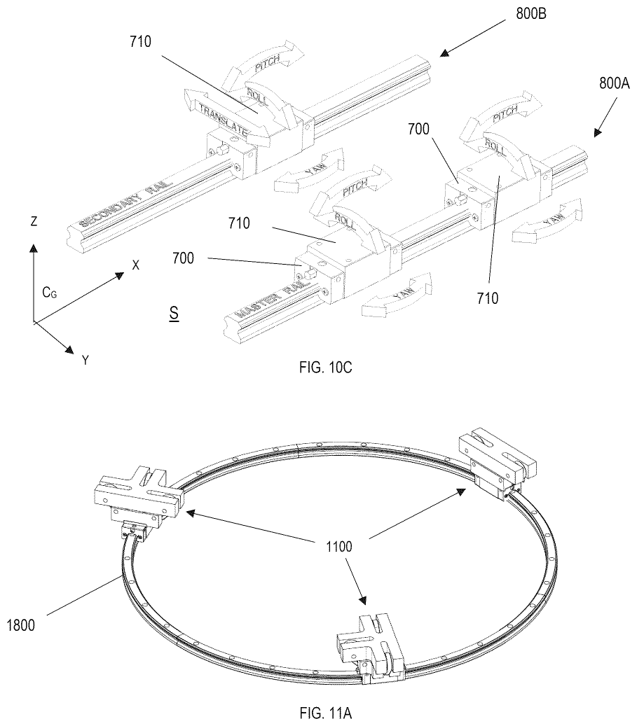

The nature of the three-link version of the compensation device 100 derives from the number of link assemblies 300A, 300B, 300C. Each of the link assemblies 300 define a generally elongate, oval-shaped link housing 305 configured to define a first end 310 and a second end 320. Within these two ends, a pair of spherical (or orbital) bearings 312, 322 are mounted within the link housing 305 to extend from one major surface of the link housing 305 to the other. As will be discussed in more detail herein, the spherical bearings 312, 322 permit a certain amount of bearing roll, pitch and yaw self-alignment capability in the three-link version. The same spherical bearings 312, 322 permit a certain amount of roll, pitch and yaw, as well as translation movement, in the two-link version that is particularly beneficial in use instances where a pair of rails 800 are used in conjunction with one another, such as to form a parallel track (that is to say, railroad track-like) material transport system 4000 (also referred to as a material handling system) as depicted in FIGS. 10A through 10C. As such, the embodiments of the compensation device 100 and all of its subsequently discussed varying embodiments may be thought of as load bearing pillow blocks. As can be seen, the link assemblies 300 may be formed in either two or three of the corners of the inner block 200. It will be appreciated that the term “corner” need not necessarily imply a linear right-angle joining of two generally planar adjacent surfaces, but may also include a slight degree of roundedness, non-planarity or even angular or related offset at the location where the adjacent surfaces meet, and as such means that these minor deviations are still deemed to constitute a corner within the context of the present disclosure. Although as shown each link assembly 300 forms a 30^{o} angle relative to the plane of motion formed by the first axis X and the second axis Y, it will be appreciated that such angle may vary, depending on the loads and orientation of the geometric particulars of the compensation device 100.

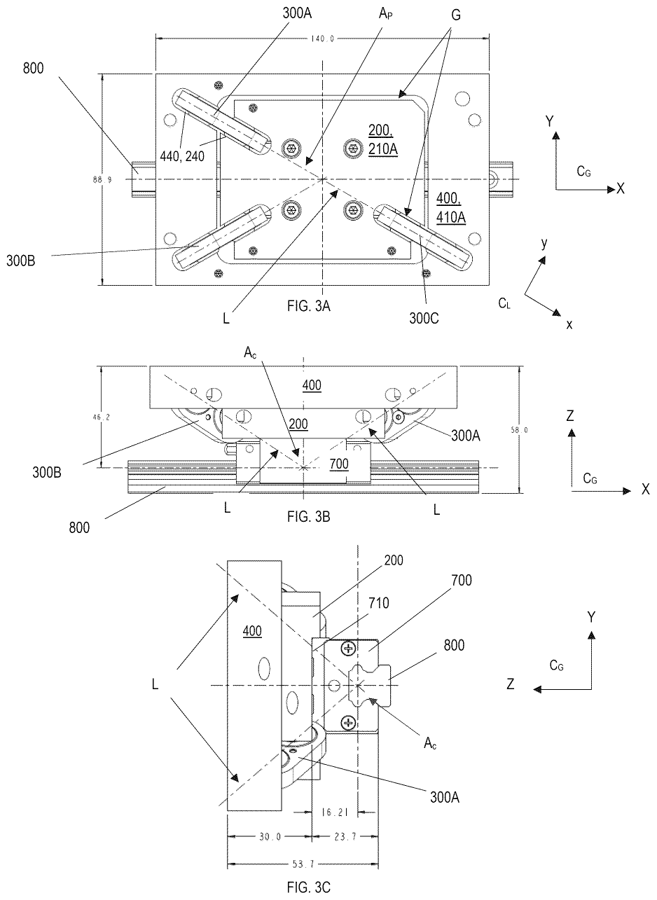

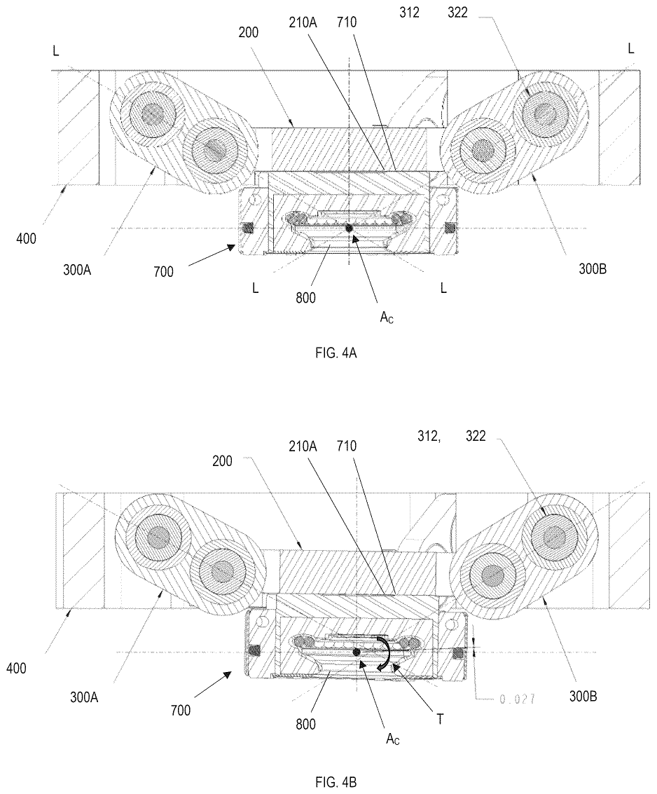

The outer block 400 defines a substantially rectangular three-dimensional shape, although (like the inner block 200) it will be appreciated that other shapes are within the scope of the present disclosure so long as they provide the necessary cooperation with the inner block 200 and link assemblies 300. The outer block 400 includes a pair of opposing major surfaces 410A, 410B (collectively 410) that are bounded by numerous minor surfaces 420A, 420B, 420C and 220D (collectively 420). In one form, major surface 410A defines a generally upward-facing mounting block surface, carriage plate surface, bearing block surface or related structure, depending on whether the outer block 400 is directly or indirectly secured to a workpiece (not shown). Likewise, the major surface 410B defines an opposing (that is to say, downward-facing) surface. As can be seen, the outer block 400 also defines a larger footprint within a plane that is defined by the first axis X and the second axis Y than the inner block 200 so that the latter may fit into the former in the nested manner described herein. As with the relationship between the link assemblies 300 and the inner block 200, outer blocks 200, 400 have slots 440 formed in the corners that align with the slots 240 of the inner block 200 to form a slot pair (also referred to herein as an inner and outer block slot pair). As with the slots 240 of the inner block 200, the slots 440 of the outer block 400 are slightly wider than the link assemblies 300 that are placed therein to allow for the pivoting movement of the latter in response to a load that operates outside of a center of action of the load bearing 700 as will be discussed in more detail in conjunction with FIGS. 3A through 3C, 4A and 4B. In this way, a load associated with a workpiece (such as that shown in conjunction with FIG. 10A) that rests upon the outer block 400 that doesn't pass through a center of action of the load bearing 700 as will be at least partially absorbed by the orbital or rotational cooperation of the outer block 400, link assemblies 300 and the inner block 200 that make up the compensation device 100 to cause the load to be aligned with such center of action.

A series of shafts 500 define elongate tubular elements that in one form resemble a dowel pin. Each shaft 500 is sized to fit within corresponding alignable bores 230, 430 that are formed respectively in each of the inner and outer blocks 200, 400 to provide support of the link assemblies 300 relative to the inner and outer blocks 200, 400 to allow a limited range of movement between them. Within the present disclosure, it will be appreciated that such movement includes at least rotational movement about a Cartesian space defined by the inner and outer blocks 200, 400, the shafts 500 or other mutually-orthogonal three-dimensional reference framework. The relative movement of the link assembly 300 to one or the other of the inner block 200 and outer block 400 includes both single-axis rotational roll (about the first axis X), yaw (about the third axis Z) or pitch (about the second axis Y) movement made possible by the ability of the link assembly 300 to pivot about a local single Cartesian axis that is defined by one of the shafts 500, as well as swaying (that is to say, multi-axis) movement made possible by the spherical bearings 312, 322. Within the present context, it will be appreciated that numerous Cartesian frameworks may be used to define the various movements discussed herein. For example, the global Cartesian framework C_{G} depicted in FIG. 1A may be used to describe the placement of one or more of the compensation device 100, load bearing 700 and rail 800 in an operating environment, while another three-dimensional reference system (such as depicted in FIG. 3A) may comprise the aforementioned local Cartesian framework C_{L} to describe the orientation of the link assemblies 300 within the compensation device 100.

Connectors 510, 520, 530 may include one or more conventional fasteners such as set screws, socket head cap screws, button head cap screws or the like. The various components that make up the compensation device 100 may be secured to one another using one of more of the connectors 510, 520, 530, as well as to the load bearing 700, such as through the inner block 200. In a similar manner, the boot 600 (which can be made of any suitable formed, cast or related material such as metals, plastics or the like) may be secured to one or more of the compensation device 100 and load bearing 700 through one or more of the connectors 510, 520, 530.

Referring with particularity to FIG. 1D, a two-link version of the compensation device 100 is shown. In general, it is of similar construction to the three-link version with the exception of having only two of the link assemblies 300A and 300C that are formed in diagonally-opposed corners of the inner block 200 and outer block 400. As will be discussed elsewhere, whereas the three-link version provides three rotational degrees of freedom about the roll, yaw and pitch axes, the two-link version provides three rotational degrees of freedom about the roll, yaw and pitch axes as well as one translational degree of motion, specifically along a lateral dimension along the second axis Y that is orthogonal to and within the plane of the first axis X of travel of the compensation device 100 when attached to the load bearing 700.

Referring next to FIGS. 3A through 3C, operation of the compensation device 100 in situations where there is no substantial misalignment between the load bearing 700 and a rail 800 is shown. The link assemblies 300 are positioned so that an imaginary line L that passes through an elongate center (also called a link centerline) of the spherical bearings 312, 322 in each also intersects with the center of action (also referred to herein as center of load bearing capacity) A_{C} of the load bearing 700. Stated another way, each link assembly 300 points to the center of action A_{C} of the load bearing 700. In one form (such as where the compensation device 100 defines a substantially rectangular structure with an even weight distribution), the center of action A_{C} generally coincides with a center of action of the compensation device 100, although this need not always be the case. As seen with particularity in FIG. 3A, the alignment of two of the link assemblies 300A, 300C along their elongate axes within the slots 240, 440 that are themselves aligned along a diagonal axis that extends through both the inner and outer blocks 200, 400 coincide with a pivoting axis A_{P} that in one form may coincide with a roll axis about the first axis X within the local Cartesian framework C_{L}. In this manner, link assemblies 300A, 300C form—as shown in FIG. 1C—a link assembly set 300_{S} in that they cooperate together along a common axis to permit a limited range of corner-to-corner tipping motion of the inner block 200 relative to the outer block as well as a limited range of corner-to-corner tipping motion of the inner block 200 relative to the bearing rail assembly 700. As shown with particularity in FIG. 3B, a line of action that in one form corresponds to a primary load path from the first end 310 to the second end 320 of each link assembly 300 is such that upon placement of the link assemblies 300A, 300B, 300C, the line of action substantially intersects the center of action A_{C} of the load bearing 700. In a related manner as shown in FIGS. 1B, 1C, 2A and 3A, a movable coupling is formed by each individual link assembly 300A, 300B and 300C and their corresponding facingly-adjacent slots 240, 400 that are formed in the facingly-adjacent corners of the inner block 200 and the outer block 400.

Proper sizing of both the inner and outer blocks 200, 400 allows a slight gaps G to be formed between the outer periphery of the former and the inner periphery of the latter. Relatedly, proper sizing between each of the link assemblies 300 and their respective slots 240, 440 that are formed within both the inner and outer blocks 200, 400 allows for a comparable gap G to be formed. It is both of these gaps G that allow limited third axis Z rotation of the inner block 200 relative to the outer block 400, as well as limited third axis Z rotation of the link assemblies to one or both of the inner block 200 relative to the outer block 400. Likewise, the construction of the spherical bearings 312, 322 within each link assembly 300 permits additional degree-of-freedom movement of the link assembly 300 relative to the inner and outer blocks 200, 400.

Referring next to FIGS. 4A and 4B, operation of the three-link version of the compensation device 100 to correct for potential misalignment of the major surface 210B of the inner block 200 relative to the upward-facing major surface 710 of the load bearing 700 is shown. Referring with particularity to FIG. 4A, conventionally, a load (whether in tension or compression) being transmitted through any link (including link 300) passes along the direction of the centerline of that link. Thus, and referring with particularity to FIG. 4B, when movement of a connection link 300 centerline occurs as a result of misalignment between the compensation device 100, the load bearing 700 and the rail 800, the link centerlines L do not pass through the center of action A_{C} of the load bearing 700, causing some torque T to be produced in that a moment about the center of action A_{C} is induced in the load bearing 700. Insofar as load bearings (including the load bearings 700 discussed herein) are rated for a certain amount of torque, it will be appreciated that exceeding that rating will reduce the life of such bearing that in turn can lead to premature failure. By correcting for certain amounts of misalignment between the load bearing 700 and the rail 800, the compensation device 100 allows for a wider range of operation without exceeding the allowable torque ratings of the load bearing 700.

By way of example, when the load bearing 700 tilts from a substantially parallel orientation (such as shown with particularity in FIG. 4B), its center of action A_{C} will move upward a small amount (for example the compensation device 100 tilts 1°, causing the center of action A_{C} to move upward 0.027 mm (0.0011″). It will be appreciated that these numbers are merely for explanation purposes and are not intended to limit that amount of compensation provided by the compensation device 100, and that greater or smaller amounts of such tilting or movement may occur, depending on the permissible limits of the amount of allowable misalignment as set forth by the manufacturer of a particular type of load bearing 700, as well as any of its combined linear bearing X, Y, Z and torque load ratings.

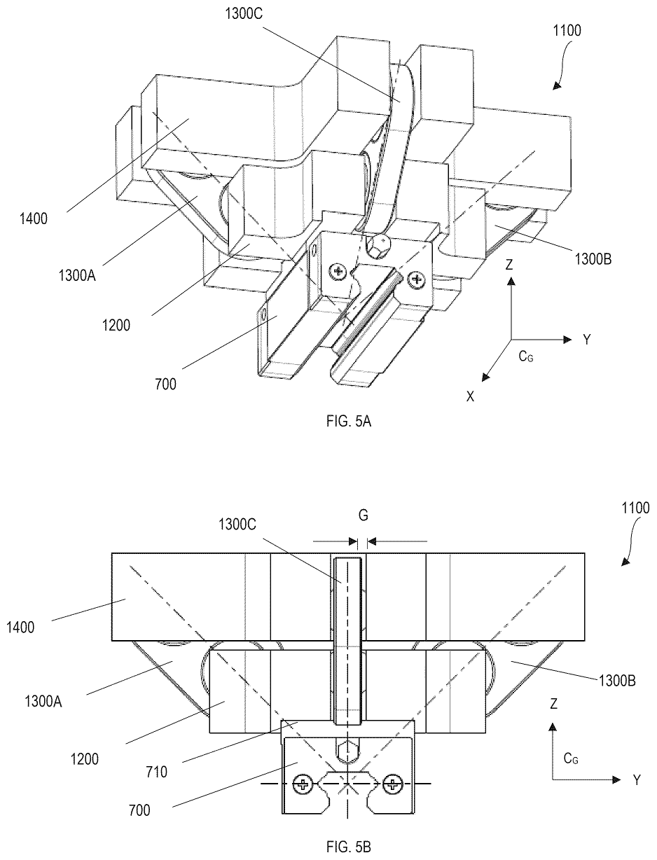

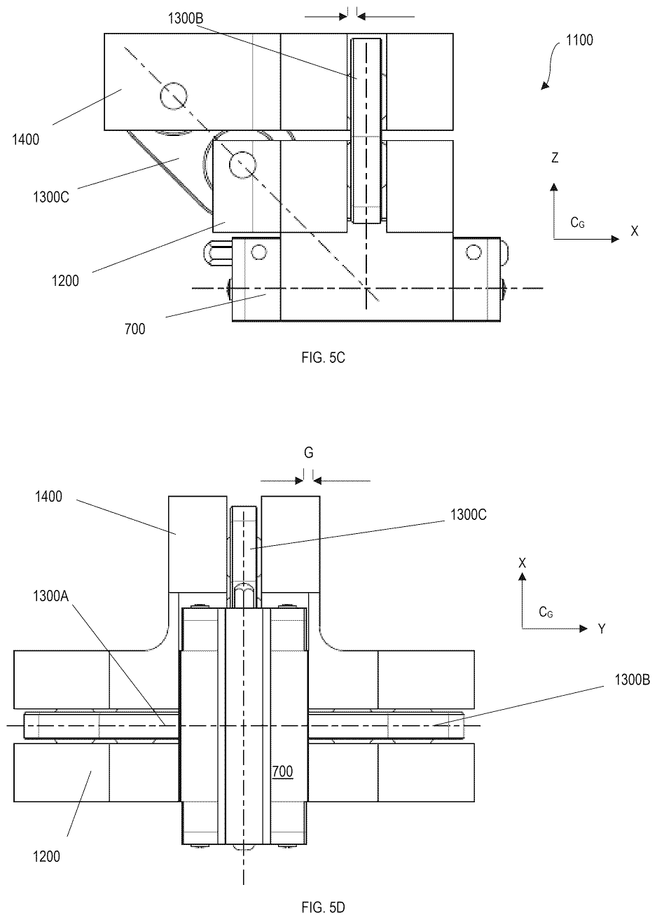

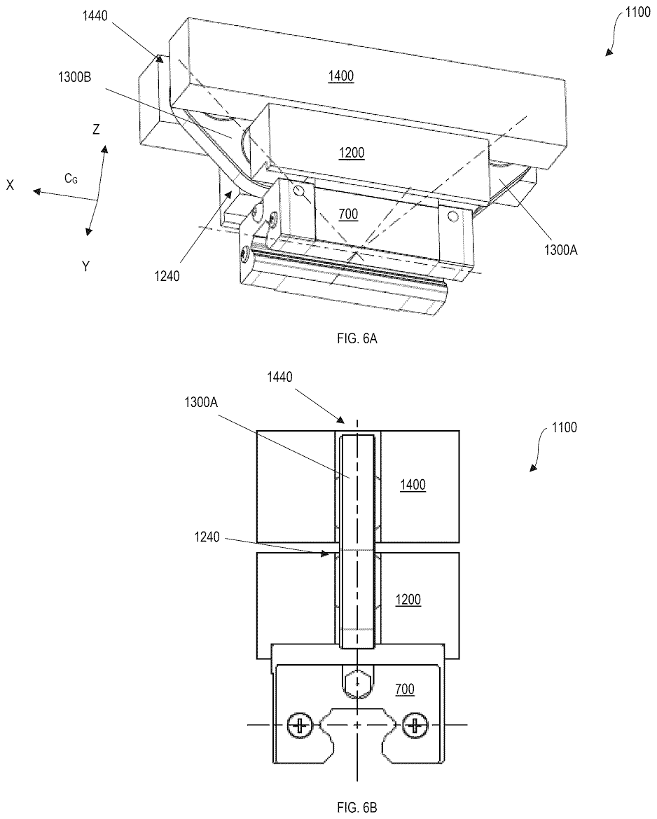

Referring next to FIGS. 5A through 5D, a three-link version of a different embodiment compensation device 1100 is shown. As with the previously-discussed embodiment, its nature of derives from the number of link assemblies 1300A, 1300B, 1300C (collectively 1300) all of which may—in one form—be substantially identical to the previously-discussed link assemblies 300A, 300B and 300C. Unlike the link assemblies 300 that were oriented along their elongate axes that extended from their first end 310 to their second end 320 that were diagonal relative to the direction of travel of the underlying load bearing 700, the link assemblies 1300 occupy different positions with a different inner block 1200 and outer block 1400 such that the link assemblies 1300 are oriented along their elongate axes to be either aligned with or orthogonal relative to the direction of travel of the load bearing 700. In other words, one or more of the link assemblies 1300A, 1300B may couple the inner block 1200 to the outer block 1400 at respective lateral sides (that is to say, sides that face the second axis Y as shown) thereof while one or more of the link assemblies 1300C may couple the inner block 1200 to the outer block 1400 at respective longitudinal sides (that is to say, sides that face the first axis X as shown) thereof. As such, the slots 1240 1440 that are formed in the respective inner and outer blocks 1200, 1400 are oriented along either the first axis X or second axis Y of the global Cartesian framework C_{G}. In addition, unlike the nested arrangement between inner and outer blocks 200, 400 of the previous embodiment, the inner and outer blocks 1200, 1400 of the present embodiment are either integrally formed with one another (such as through casting, additive manufacturing or the like) or stacked and secured to one another (such as through fasteners, friction or coupling effected by the link assemblies 1300 in which case a small gap between adjacently-facing major surfaces may be in evidence). It will be appreciated that in a variation (not shown) a hybrid construction that exhibits features of both stacking and nesting is also within the scope of the present disclosure. In one form, such a hybrid construction would generally resemble the manner in which the upper portion of the load bearing 700 engages the lower portion of the inner block 200 of FIGS. 1B, 2A and 3C. Moreover, it will be appreciated that the term “block” as used in the present disclosure to describe the structure and substructure and may assume various shapes as depicted herein. For example, they may in one form resemble the shapes that are capable of the aforementioned nested cooperation and interior mounting of the link assemblies, while in another form resemble the flanged shapes that are capable of exterior mounting of the link assemblies. As such, shapes such as these—as well as their mounting, structural and functional equivalents—are deemed to be within the scope of the present disclosure.

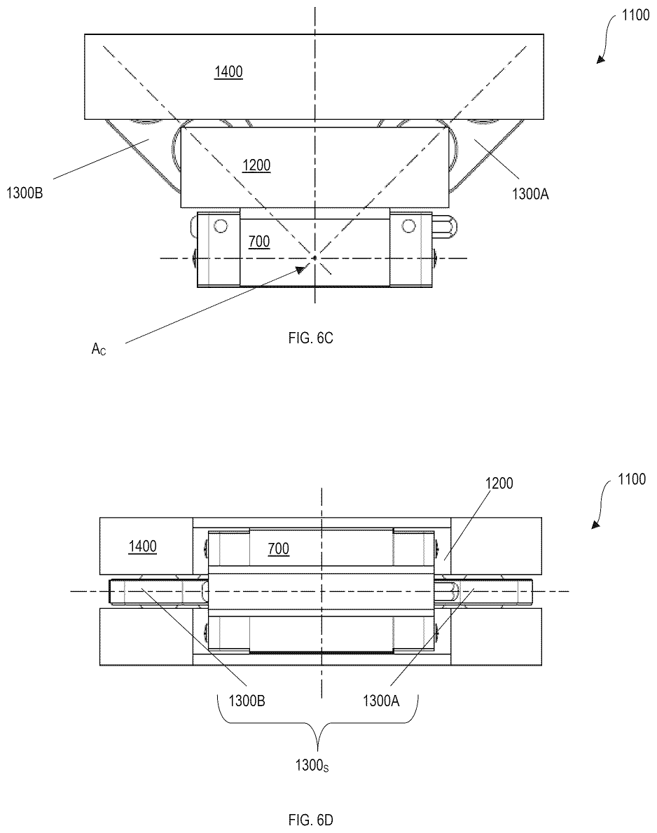

Referring next to FIGS. 6A through 6D, a two-link version of the compensation device 1100 shows respective link assemblies 1300A and 1300B. While the inner block 1200 and outer block 1400 generally resemble those of the three-link version of FIGS. 5A through 5D (including their ability to be arranged in a stacked construction), they could also be arranged in a nested fashion (not shown) that is generally similar to that of FIGS. 1A through 4B. Furthermore, the inner block 1200 and the outer block 1400 differ from their three-link counterparts in both the number of slots 1240, 1440 formed therein and the location and orientation of the opposing set of aligned link assemblies. In this case, the two link assemblies 1300A and 1300B cooperate together as part of a link assembly set 1300_{S} that is shown with particularity in FIG. 6D and which functions in a manner generally similar to the link assembly set 300_{S} of FIG. 1C. In this way, the link assemblies 1300A, 1300B are oriented along the elongate axis of the compensation device 1100 to be aligned with the direction of travel of the load bearing 700. In one form, their elongate axes (shown in dashed line in FIGS. 6A and 6C) extend in a plane defined by the first and third axes X, Z of the global Cartesian framework C_{G} to intersect at the center of action A_{C} of the load bearing 700, as shown with particularity in FIG. 6C. As discussed elsewhere, the link of each link assembly 1300A, 1300B has a centerline that passes through or near the center of both orbital bearings (not shown, but similar in construction to spherical bearings 312, 322 of FIG. 1A). In this way, each link is arranged so that its centerline passes through or near the center of action A_{C} of the load bearing 700. With such construction, the compensation device 1100 can provide a measure of rotational freedom of motion about each of the three major axes of the global Cartesian framework C_{G} as well as a measure of lateral translational freedom of motion (that is to say, along the second axis Y).

It will be appreciated that although the embodiment of FIGS. 6A through 6D show a single two-link compensation device 1100, additional ones of the two-link compensation device 1100 may be placed on a single bearing 700. For example (not shown), a pair of two-link compensation devices 1100 may be placed such that they are aligned along the elongate dimension of the bearing 700 to act along the same (that is to say, first axis X) with one axially in front of the other, each at substantially opposite ends of the bearing 700, thereby still preserving the translational freedom of motion along the second axis Y. This and other orientations and numbers of the two-link compensation device 1100 are thus deemed to be within the scope of the present disclosure.

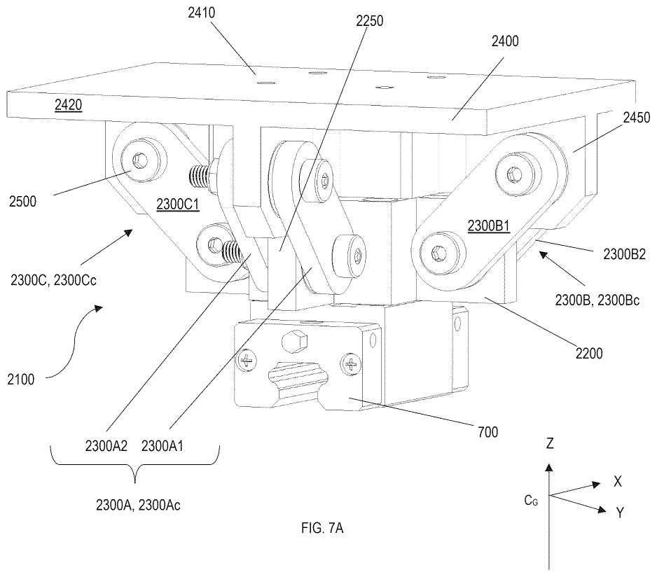

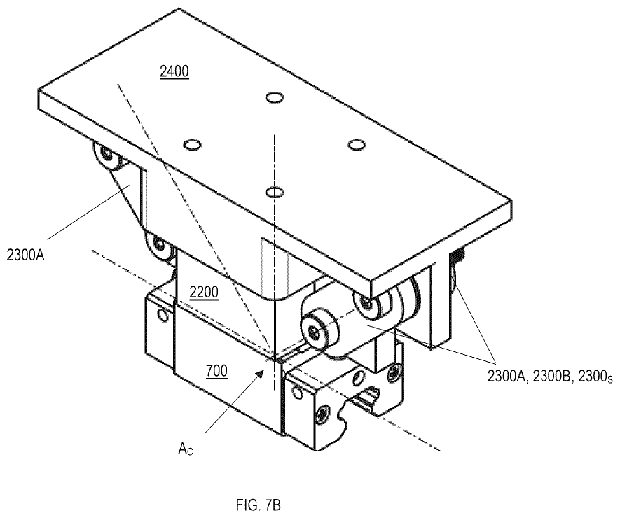

Referring next to FIG. 7A, a three-link version of a compensation device 2100 according to yet another embodiment is shown. Unlike the prior embodiments, each of the link assemblies 2300A, 2300B, 2300C (collectively 2300) is now formed as individual link couples 2300Ac, 2300Bc, 2300Cc. By way of example, the first link couple 2300Ac is actually formed from two substantially identical links 2300A1 and 2300A2 that are arranged in a side-by-side construction with one another to define the link assembly 2300A, separated by flanges 2250 and 2450 that are formed in the respective inner block 2200 and outer block 2400. As with the previous embodiments, the inner and outer blocks 2200, 2400 have corresponding major surfaces and minor surfaces of which only the major surface 2410 and the minor surface 2420 of the outer block 2400 is shown. As can be seen, the flanges 2250 and 2450 function as structurally rigid mount locations for the link assemblies 2300A, 2300B, 2300C. Such construction provides an additional measure of strength for the assembly made of flanges 2250, 2450 and the link assemblies 2300A, 2300B, 2300C. In one form, numerous shafts 2500 are used to secure the two substantially identical links 2300A1 and 2300A2 of the first link couple 2300Ac together, as is the case for the second and third first link couples 2300Ab and 2300Ac. Otherwise, the shafts 2500 function in a manner generally similar to the shafts 500 of the first embodiment.

Unlike the previous embodiments (such as depicted in FIGS. 1A through 1C, 4A and 4B), the spherical bearings of the embodiment of FIGS. 7A and 7B are encased in the flanges 2250 and 2450 instead of in the individual link assemblies 2300A, 2300B, 2300C or their corresponding link couples 2300Ac, 2300Ab and 2300Ac. As with the inner and outer blocks 1200 and 1400 of the previous embodiment, particular shapes are employed to promote block-to-block cooperation with one another through the link assemblies 2300A, 2300B, 2300C. In this regard, the inner block 2200 and outer block 2400 have more in common with their counterparts in the embodiment of FIGS. 5A through 6D than they do with the embodiment of FIGS. 1A through 4D in that block nesting is not needed. Regardless of the form, it will be appreciated that any of the outer blocks 400, 1400 and 2400 depicted herein function as one particular form of the structure in that they all may provide direct or indirect support of a load that corresponds to a workpiece being conveyed along a rail. Likewise, it will be appreciated that any of the inner blocks 200, 1200 and 2200 functions as one particular form of the aforementioned substructure.

It will be appreciated that within a Cartesian space that permits the aforementioned six degrees of freedom, by orienting the link assemblies 300, 1300, 2300 of all of the embodiments depicted in FIGS. 1A through 6D as well as the link assemblies 3300 of FIGS. 7A and 7B to substantially point toward the center of action A_{C} of the load bearing 700, undue loading on the load bearing 700 due to uneven, bent, curved, warped or misaligned support surfaces can be reduced or substantially eliminated. By such construction, the three-link version provides three degrees of rigidity and three degrees of freedom, while the two-link version provides two degrees of rigidity and four degrees of freedom.

Referring next to FIG. 7B, a two-link version of the compensation device 2100 of FIG. 7A is shown. As with the embodiments of FIGS. 6A through 6D relative to the embodiments of FIGS. 5A through 5D, the inner block 2200 and outer block 2400 generally resemble those of the three-link version of FIG. 7B (including their ability to be arranged in a stacked construction), they could also be arranged in a nested fashion (not shown) that is generally similar to that of FIGS. 1A through 4B. Furthermore, the inner block 2200 and the outer block 2400 differ from their three-link counterparts in both the number, location and orientation of the flange-based mounting the of aligned link assemblies 2300. As before, two link assemblies 2300A and 2300B cooperate together as part of a link assembly set 2300_{S} that functions in a manner generally similar to the link assembly set 300_{S} of FIG. 1C. In this way, the link assemblies 2300A, 2300B are oriented along the elongate axis of the compensation device 2100 to be aligned with the direction of travel of the load bearing 700.

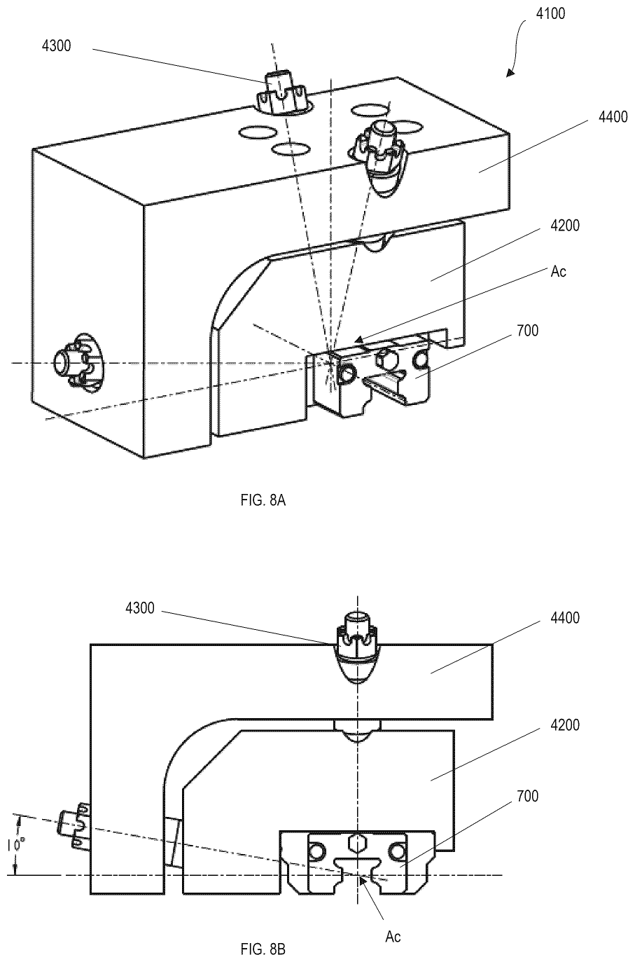

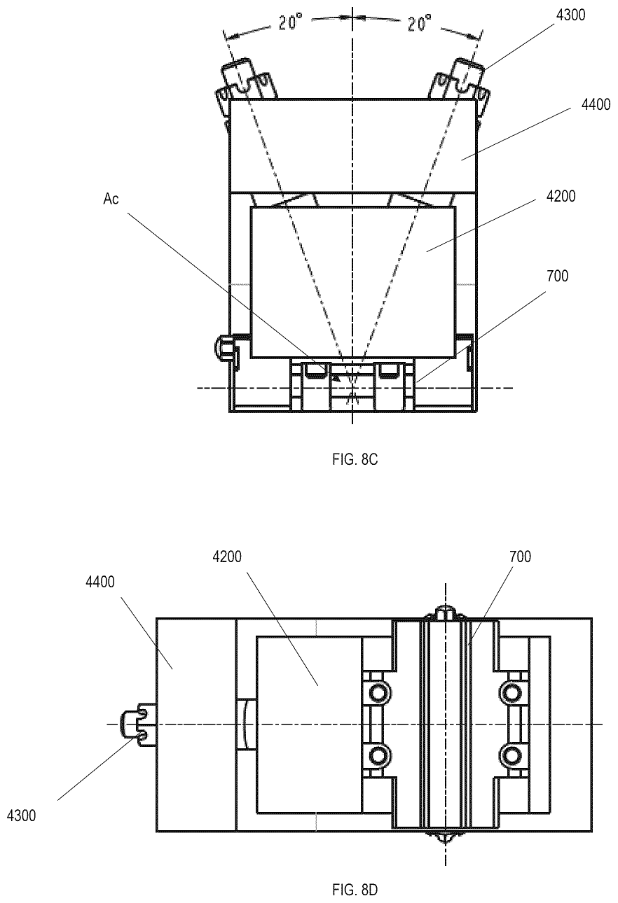

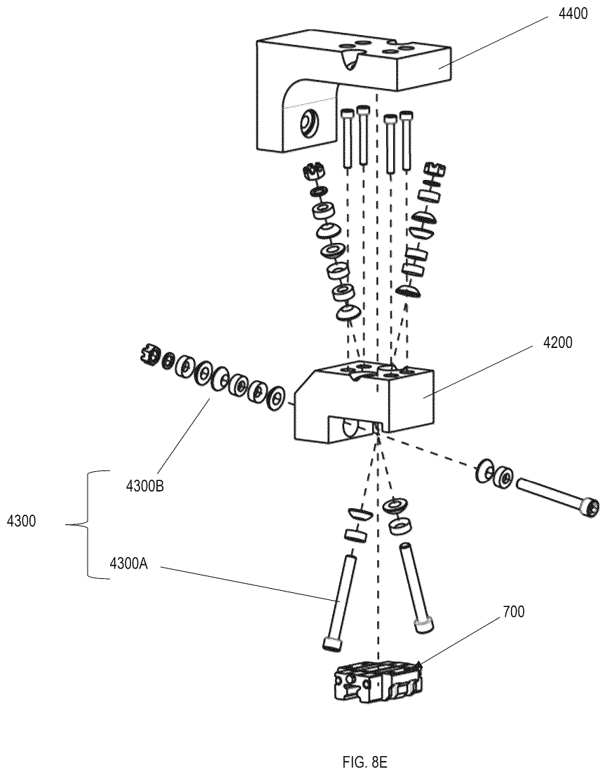

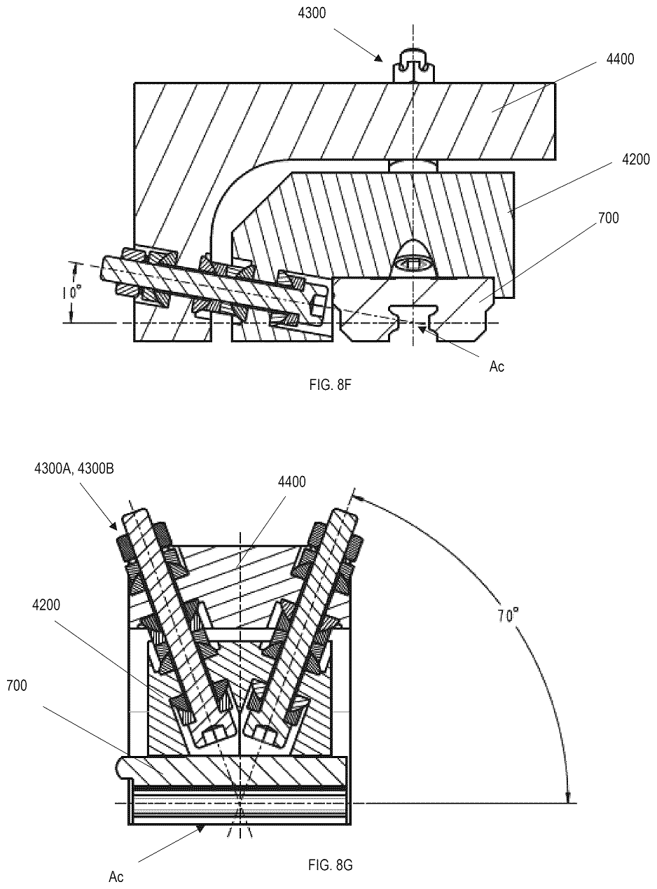

Referring next to FIGS. 8A through 8G, a three-link version of a compensation device 4100 according to yet another embodiment is shown. An inner block 4200 and outer block 4400 provide the connectivity and support the latter of which may be in the form of any of the previous substructures and structures. Unlike the prior embodiments, the link assemblies 4300 of the compensation device 4100 utilize bolts 4300A and spherical washers 4300B.

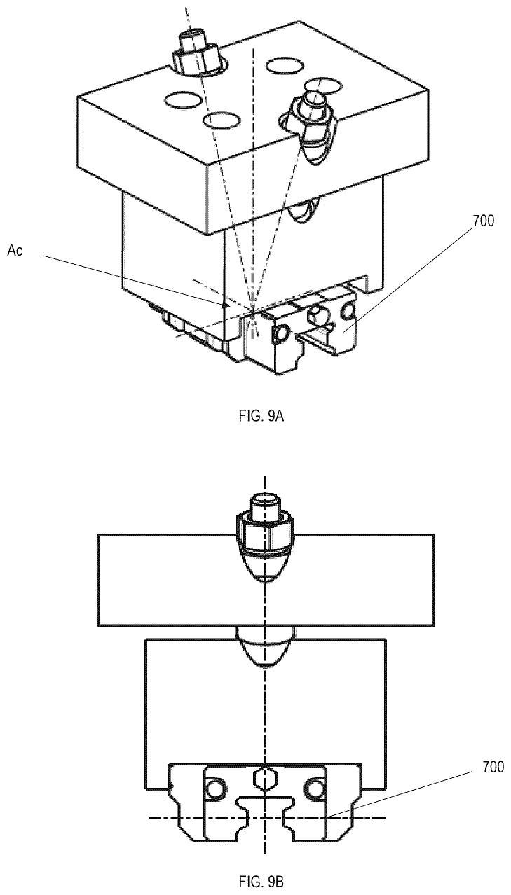

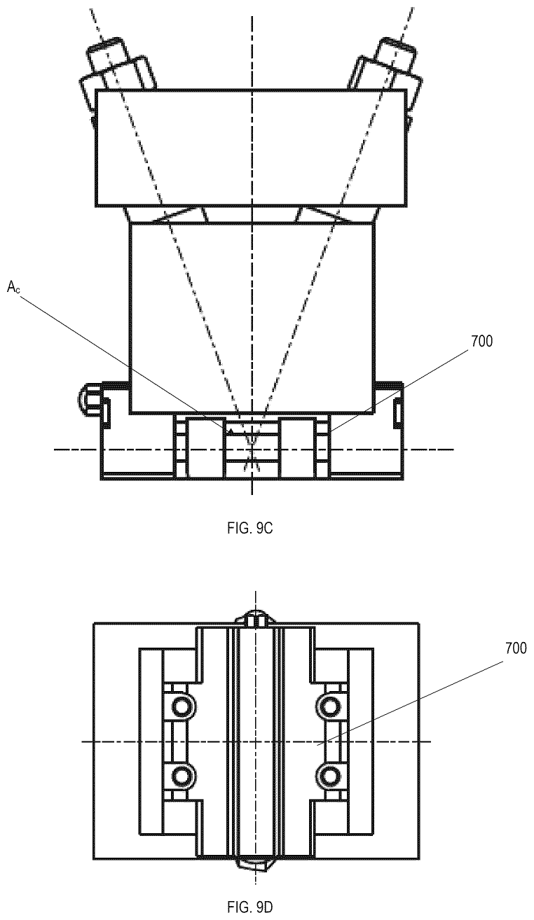

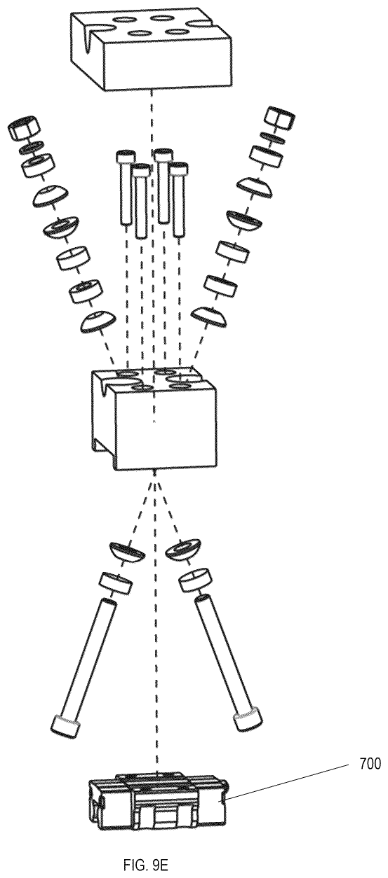

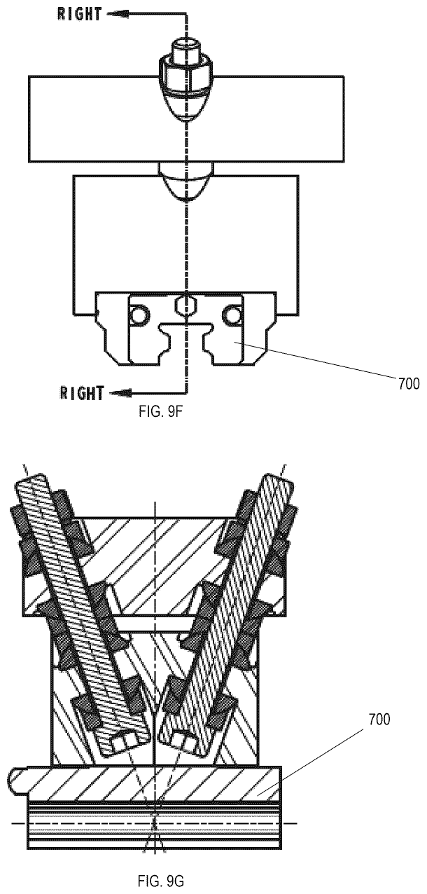

Referring next to FIGS. 9A through 9G, a two-link version of the compensation device 4100 of FIGS. 8A through 8G is shown and where the inner block 4200 and outer block 4400 are suitably modified to account for smaller number of link assemblies 4300.

Referring next to FIGS. 10A through 10C, the use of both two-link and three-link versions of the compensation devices 1100 that correspond to the embodiments of FIGS. 5A through 6D are shown as part of a two-rail material transport system 5000. It will be understood that the use of the compensation device 1100 is merely by way of an example, and that the other embodiments of the various compensation devices 100, 2100 and 3100 may be used instead, depending on the need. As shown, the compensation device 1100 coupled to load bearing 700 forms a linear rail bearing assembly 5100. In use, the material transport system 5000 is placed on a support surface S that may or may not be sufficiently flat for the purposes of remaining within the tolerance specifications of the load bearing 700. In one form, the compensation device 100, load bearing 700 and parallel rails 800 make up the material transport system 5000 in order to convey a workpiece, robot, gripper or other device (collectively “workpiece”, not shown) from one place to another. In one form, such conveying may include taking the workpiece from a first station (not shown) along a substantially linear path to a second station (not shown), such as part of an assembly line used in manufacturing. In one form, the workpiece may include automotive components, while in another a machine that is itself used to perform various manufacturing operations at different locations within a manufacturing facility. The workpiece may be placed on a suitable engaging surface (for example, an upward-facing major surface 1410A of the outer plate 1400 of FIG. 1A. As noted previously, the major surface 1410A defines a generally mounting block surface, carriage plate surface, bearing block surface or related structure such that when the material transport system 5000 is conveying the workpiece along the parallel rails 800, the workpiece remains relatively at rest relative to the compensation device 100. In such configuration, the workpiece is deemed to be riding upon (including resting upon), secured to (such as by affixing) or otherwise coupled to the compensation device 100.

Referring with particularity to FIGS. 10B and 10C, the parallel rails 800 include a primary rail 800A and a secondary rail 800B, where by convention the primary rail 800A serves as a positional reference for the material transport system 5000 or other motion system. Referring with even greater particularity to FIG. 10C, the rails 800A, 800B may be arranged so that a pair of axially-aligned three-link versions of the compensation devices 1100 (not presently shown for clarity) on the primary rail 800A provide roll, pitch and yaw freedom of motion to a primary rail 800A while a single two-link version of the compensation device 1100 (not presently shown for clarity) provides lateral translational freedom of motion along the second axis Y of a secondary rail 800B. Within the present disclosure, it will be appreciated that any of the compensation devices 100, 1100, 2100, 3100 or 4100 may be used, including (depending on the end use) combinations thereof. The use of the three-link version of the compensation device 1100, properly arranged on an upward-facing major surface 710 of the load bearing 700 that is mounted on primary rail 800A provides it with three rotational axes of motion: roll, pitch and yaw while substantially inhibiting (that is to say, placing a restraint on) any lateral translational movement along its center of action A_{C} along the any of the first, second and third axes X, Y and Z. Contrarily, the two-link version of the compensation device 1100 provides its corresponding load bearing 700 mounted on secondary rail 800B with those three rotational axes of motion plus a lateral translation freedom of motion along the second axis Y. In this way, the three-link versions of the various compensation devices 100, 1100, 2100, 3100 or 4100 (as well as functional equivalents thereof) may provide three degrees of rotational freedom for two bearing blocks that are mounted on the primary rail 800A. As discussed in conjunction with FIGS. 4A, 4B and 6C, this rotation pivots around a point at or near the center of action A_{C} of the load bearing 700, providing the necessary compensation for misalignment while maintaining repeatable location accuracy.

It will be appreciated that by having at least one two-link version of the compensation device 100, 1100, 2100, 3100 or 4100 mounted on the secondary rail 800B, translational compensation that is approximately perpendicular to the linear motion of the material transport system 5000 is facilitated, and that such translational motion takes place at or near parallel to a plane that passes through both the primary and secondary rails 800A, 800B. This is particularly beneficial for actual environments where a limited amount of rail 800A and 800B non-parallel alignment is present.

It will be appreciated that traditionally a support surface upon which a material transport system or other equipment that employs a linear rail bearing is placed must be manufactured to precise (that is to say, flat, straight and strong idealized) standards. Likewise, in uses where two-rail bearing systems are employed, the rails are required to be precisely parallel. Current practice often employs such support surfaces to be made from steel weldments that are stress relieved and precision machined, all of which significantly increases costs. Recognizing that any given support surface may not be manufactured to a degree of precision to ensure that there is no unevenness, bends, curving, warpage, flexibility or misalignment within the support surface, the compensation devices 100, 1100, 2100, 3100 or 4100 as disclosed herein—when coupled to linear rail bearings such as the ones depicted herein—enable such bearings and the rails to which they are slidably secured allows a fabricator or user of a material transport system to avoid or reduce much more expensive machining and related operations.

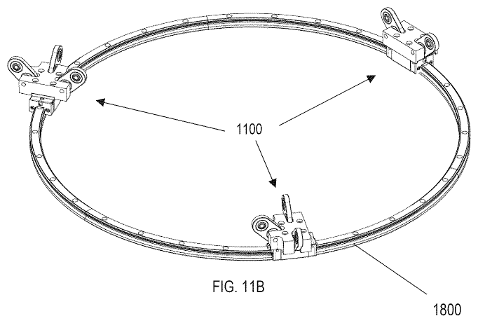

Referring next to FIGS. 11A and 11B, as previously noted, much of the present disclosure discusses the specific interaction of the compensation device 100 with a linear rail bearing as a particular form of the load bearings 700. Relatedly, it will be appreciated that the various embodiments of the compensation device 100, 1100, 2100, 3100 and 4100 disclosed herein may be used with curved rails 1800. For example, such rails 1800 in circular form may be made to support rotary tables, turrets and similar rotary motion equipment (not shown). The compensatory features provided by any of the compensation devices 100, 1100, 2100, 3100, 4100 can also be applied to circular track bearings (not shown), including either or both of the two-link and three-link versions. It will be appreciated that the centerlines of the link assemblies that make up the three-link version of the compensation devices 100, 1100, 2100, 3100, 4100 point to or near the center of action of the curved rail bearing. Additional two-link versions of the compensation devices may be installed for additional load carrying capacity. This arrangement provides the curved rail bearing with substantially or approximately rigid support in two of the Cartesian axes (that is to say, the first axis X and the second axis Y), and four substantial or approximate degrees of freedom (specifically, translationally along the third axis Z and rotationally about the load bearing 700 center of action A_{C} in the roll, pitch and yaw axes). Thus (and as previously mentioned), while much of the discussion herein focuses on linear rail bearings 700 that are to be used with straight rails 800, the alignment compensation devices 100, 1100, 2100, 3100, 4100 disclosed herein can be applied to support any load bearing 700, including radial, angular contact, thrust, crossed roller, linear or the like.

Within the present disclosure, the alignment compensation devices 100, 1100, 2100, 3100 and 4100 and their associated link assemblies 300, 1300, 2300, 3300 and 4300 are shown as connecting to the load bearing 700 indirectly through intermediary devices (specifically, the inner and outer blocks 200, 400 of FIGS. 1A through 4B and their equivalents in the other figures). It will be appreciated that such connectivity may be achieved directly (that is to say, without any intervening structure or substructure), such as through integral link anchor points (not shown), and that either form form of connectivity is within the scope of the present disclosure. In such case, the compensation device may include numerous link assemblies each of which is movably coupled directly to the load bearing 700. In such a configuration each of the link assemblies includes a link housing and a pair of orbital bearings. In this way, the bearing may be rotationally self-aligned to allow the needed rotational freedom of motion between the compensation device and the load bearing 700 about each of the roll axis, pitch axis and yaw axis of the load bearing 700 at a location that is substantially at its center of action A_{C}.

Within the present disclosure, one or more of the following claims may utilize the term “wherein” as a transitional phrase. For the purposes of defining features discussed in the present disclosure, this term is introduced in the claims as an open-ended transitional phrase that is used to introduce a recitation of a series of characteristics of the structure and should be interpreted in like manner as the more commonly used open-ended preamble term “comprising” and its variants that do not preclude the possibility of additional acts or structures.

Within the present disclosure, terms such as “preferably”, “generally” and “typically” are not utilized to limit the scope of the claims or to imply that certain features are critical, essential, or even important to the disclosed structures or functions. Rather, these terms are merely intended to highlight alternative or additional features that may or may not be utilized in a particular embodiment of the disclosed subject matter. Likewise, it is noted that the terms “substantially” and “approximately” and their variants are utilized to represent the inherent degree of uncertainty that may be attributed to any quantitative comparison, value, measurement or other representation. As such, use of these terms represents the degree by which a quantitative representation may vary from a stated reference without resulting in a change in the basic function of the subject matter at issue.

Within the present disclosure, the use of the prepositional phrase “at least one of” is deemed to be an open-ended expression that has both conjunctive and disjunctive attributes. For example, a claim that states “at least one of A, B and C” (where A, B and C are definite or indefinite articles that are the referents of the prepositional phrase) means A alone, B alone, C alone, A and B together, A and C together, B and C together, or A, B and C together. By way of example within the present disclosure, if a claim recites translational freedom of motion in at least one of a first Cartesian axis, a second Cartesian axis and a third Cartesian axis, and if such motion takes place along the first axis alone, the second axis alone, the third axis alone or any combination of the first, second and third axes, then such motion satisfies the claim.

Within the present disclosure, the following claims are not intended to be interpreted based on 35 USC 112(f) unless and until such claim limitations expressly use the phrase “means for” or “steps for” followed by a statement of function void of further structure. Moreover, the corresponding structures, materials, acts and equivalents of all means or step plus function elements in the claims that follow are intended to include any structure, material or act for performing the function in combination with other claimed elements as specifically claimed.

Within the present disclosure, the singular forms “a,” “an” and “the” include plural references unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6 to 9, the numbers 7 and 8 are contemplated in addition to 6 and 9, and for the range 6.0 to 7.0, the number 6.0, 6.1, 6.2, 6.3, 6.4, 6.5, 6.6, 6.7, 6.8, 6.9 and 7.0 are explicitly contemplated.

Having described the subject matter of the present disclosure in detail and by reference to specific embodiments, it is noted that the various details disclosed in the present disclosure should not be taken to imply that these details relate to elements that are essential components of the various described embodiments, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure may be identified as preferred or particularly advantageous, it is contemplated that the present disclosure is not necessarily limited to these aspects.

It will be apparent to those skilled in the art that various modifications and variations can be made to the described embodiments without departing from the spirit and scope of the claimed subject matter. Thus it is intended that the specification cover the modifications and variations of the various described embodiments provided such modification and variations come within the scope of the appended claims and their equivalents.

1. A compensation device for a rail bearing that is situated in Cartesian space and configured to move translatably along a major axis thereof, the compensation device comprising a plurality of link assemblies each of which is movably coupled to the rail bearing and comprises:
a link housing comprising a first end and a second end spaced apart from one another along a link housing elongate dimension, the link housing defining a plurality of apertures formed therein along a substantial centerline of the elongate dimension each of which is situated substantially at each of the first and second ends; and
a pair of orbital bearings each disposed within a respective one of the plurality of apertures and configured to rotationally self-align the rail bearing about each of a roll axis, a pitch axis and a yaw axis of the rail bearing such that in response to a load that is being carried by the rail bearing, each of the plurality of link assemblies defines:
a rotational freedom of motion between the compensation device and the rail bearing about each of the roll axis, pitch axis and yaw axis at a location that is substantially at a center of action of the rail bearing; and
a constraint on translational motion between the compensation device and the rail bearing along at least one of the major axes within the Cartesian space at the location that is substantially at the center of action of the rail bearing.

2. The compensation device of claim 1, wherein the constraint on translational motion between at least one of the link assemblies and the rail bearing along at least one of the major axes within the Cartesian space at the location that is substantially at the center of action of the rail bearing comprises a constraint on translational motion along at least two of the major Cartesian axes at the location that is substantially at the center of action of the rail bearing.

3. The compensation device of claim 1, wherein the constraint on translational motion between at least one of the link assemblies and the rail bearing along at least one of the major axes within the Cartesian space at the location that is substantially at the center of action of the rail bearing permits translational motion along at least one of the roll axis, pitch axis and yaw axis at the location that is substantially at the center of action of the rail bearing.

4.-38. (canceled)

39. A rail bearing assembly comprising:
a rail bearing that is situated in Cartesian space and configured to move translatably along a major axis thereof, the rail bearing comprising:
a rail bearing housing defining a rail-receiving slot formed therein that extends along an elongate rail axis; and
a plurality of rail engagement members are arranged within the rail bearing housing to permit linear translational movement of the rail bearing along the elongate rail axis; and
a compensation device movably cooperative with the rail bearing through a plurality of link couples each of which comprises:
a plurality of link housings each comprising a first end and a second end spaced apart from one another along a link housing elongate dimension, each of the plurality of link housings defining a plurality of apertures formed therein along a substantial centerline of the elongate dimension each of which is situated substantially at a respective one of each of the first and second ends; and
a pair of link bearings for each of the plurality of link housings, each of the pair of link bearings being disposed within a respective one of the plurality of apertures and configured to rotationally self-align the rail bearing about each of a roll axis, a pitch axis and a yaw axis within the Cartesian space such that in response to a load that is being carried by the rail bearing, each of the plurality of link housings defines a freedom of motion about each of the roll axis, pitch axis and yaw axis at a location that is substantially at a center of action of the rail bearing.

40. The rail bearing assembly of claim 39, further comprising:
a load-engaging structure secured to one of the first and second ends through a respective one of the pair of link bearings; and
a substructure secured to the other of the first and second ends through a respective one of the pair of link bearings.

41. The rail bearing assembly of claim 40, wherein the load-engaging structure comprises an outer block and the substructure comprises an inner block.

42. The rail bearing assembly of claim 41, wherein each of the pair of link bearings comprise at least one of a universal joint, a ball-and-socket, a spherical bearing, a spherical washer, an elastomeric connection, a spring steel connection and combinations thereof.

43. A material transport system comprising:
a plurality of rails arranged parallel to each other to extend along their respective elongate rail axis within a Cartesian space;
a plurality of linear rail bearings each configured to move translatably along the respective elongate rail axis, the rail bearing comprising:
a bearing housing defining a rail-receiving slot formed therein that extends along the respective elongate rail axis; and
a plurality of rail engagement members are arranged within the bearing housing to permit linear translational movement of the linear bearing along the respective elongate rail axis; and
a compensation device for each of the plurality of linear rail bearings, each compensation device comprising a plurality of link assemblies each of which is movably coupled to the linear rail bearing, each of the plurality of link assemblies comprising:
a link housing comprising a first end and a second end spaced apart from one another along a link housing elongate dimension, the link housing defining a plurality of apertures formed therein along a substantial centerline of the elongate dimension, each of the plurality of apertures being situated substantially a respective one of each of the first and second ends; and
a pair of orbital bearings each disposed within a respective one of the plurality of apertures and configured to rotationally self-align the bearing to which that compensation device is movably coupled about each of a roll axis, a pitch axis and a yaw axis within the Cartesian space such that in response to a load that is being carried by the bearing, each of the plurality of link assemblies defines a freedom of motion about each of the roll axis, pitch axis and yaw axis at a location that is substantially at a center of action of a respective one of the linear rail bearings.

44. The material transport system of claim 43, further comprising:
a load-engaging structure secured to one of the first and second ends through a respective one of the pair of orbital bearings; and
a substructure secured to the other of the first and second ends through a respective one of the pair of orbital bearings.

45. The material transport system of claim 44, wherein the load-engaging structure comprises an outer block and the substructure comprises an inner block.

46. The material transport system of claim 45, wherein:
the outer block defines an aperture formed therein such that a plurality of outer block corners are formed within the outer block and contiguous with the aperture, wherein at least a pair of the corners are arranged to be opposed to one another with each defining an outer block slot therein such that their respective outer block slots extend toward one another along an outer block first diagonal axis;
the inner block is sized to be placed within the aperture such that a gap is formed between an outer wall defined by the inner block and an inner wall of the outer block that corresponds to the aperture, the inner block defining a plurality of inner block corners in the outer wall at least a pair of which are arranged to be diagonally opposed to one another with each defining an inner block slot therein such that their respective inner block slots extend diagonally toward one another along an inner block first diagonal axis, further wherein the first diagonal axis of the inner block and the first diagonal axis of the outer block are substantially collinear with one another.

47. The material transport system of claim 43, wherein each of the plurality of rails define a prismatic cross-sectional shape.
